(19) United States
(12) Patent Application Publication
(10) Pub. No.: US 2016/0121241 A1
(43) Pub. Date: May 5, 2016

(54) LARGE-SIZED FILTER PLATE

(71) Applicant: FOSHAN JINKAIDI FILTRATION EQUIPMENT CO., LTD., Guangdong (CN)

(72) Inventor: Zhongda Pang, Guangdong (CN)

(73) Assignee: FOSHAN JINKAIDI FILTRATION EQUIPMENT CO., LTD., Guangdong (CN)

(21) Appl. No.: 14/893,953

(22) PCT Filed: Nov. 26, 2013
(86) PCT No.: PCT/CN2013/087835

§ 371 Date: Nov. 25, 2015

(30) Foreign Application Priority Data
May 28, 2013 (CN) 201310203763.1

(51) Int. Cl. B01D 25/12

(52) U.S. Cl. CPC B01D 25/12

(57) ABSTRACT

A filter plate has two sides thereof peripherally provided with different ridges each formed as a closed loop, so that when two filter plates are pressed together, the ridges at contacting sides of the adjacent filter plates are offset to jointly define a vacant space having a width of 3-5 mm. The ridges at the two sides of the filter plate have a flat top surface and a pointy or curved top surface, respectively. When the two filter plates are pressed together, the vacant space formed between the flat top surface of the ridge of one of the filter plates and the pointy or curved top surface of the ridge of the other filter plate is closed, wherein the ridge having the flat top surface forms an inner-circle sealing and the ridge having the pointy or curved top surface forms an outer-circle sealing.

### RELATED APPLICATIONS

The present application is a national stage entry according to 35 U.S.C. §371 of PCT application No.: PCT/CN2013/087835 filed on Nov. 26, 2013 which claims priority from Chinese application No.: 201310203763.1 filed on May 28, 2013, and is incorporated herein by reference in its entirety.

### TECHNICAL FIELD

Various embodiments relate to pressers, and more particularly to a large-sized filter plate.

### BACKGROUND

Pressure filters are commonly used to industrially process drainage for the purpose of environmental protection. Drainage containing sludge is processed by a pressure filter and separated into solid leach residue and water that is less muddy. Such dry leach residue occupies space much smaller than the drainage, and can be easily disposed through incineration or landfilling like normal waste. The solid-free water can be recycled, further processed and reused, or drained directly.

A conventional pressure filter typically includes a rack, filter plates, a device for driving the filter plates and filter cloth. The existing pressure filter, when used, has its filter plates pressed together and wrapped by filter cloth. Closed space is formed between the filter cloth covering the adjacent filter plates. Then drainage is fed into the closed space through the central holes of the filter plates. Since the drainage comes with high pressure, water is pushed through the filter cloth and drained form the pressure filter through water channels formed inside the filter plates. On the other hand, sludge is blocked by the filter cloth, and accumulated in the closed space between the adjacent filter plates. Having the sludge being accumulated to a certain amount, once the filter plates are released, the sludge compressed into cakes can drop out the filter cloth between the filter plates. With more and more attention focused on environmental protection and energy conservation, pressure filters are increasingly popular as they can turn large-volume drainage into small-volume filter cakes, which means significantly reduced costs for drainage process and more economic and social advantages. It is clear through the foregoing process that efficiency and effectiveness are two major measures to assess a pressure filter. While the former refers to how many tons of drainage is processed by a given pressure filter in a given time period, the latter means how low the water content in the resultant filter cakes is. All improvements made for a pressure filter are about one or both of the issues.

Presently, most filter plates have a diameter below 0.6 m. Although an enlarged filter plate may be more productive of processed sludge, and even double the working efficiency, its larger diameter brings about some solid problems. First, the greater the diameter is, the longer the circumference is. This means it is more difficult to press adjacent filter plates into a reliable sealing condition. Particularly, after removal of filter cakes, there is always some residue sticking in the sealing structure between the filter plates. In practice, one pressure filter typically has about a dozen of heavy, bulky filter plates, and it is very likely that manual clean unintentionally misses some residue. However, such residue may prevent the sealing condition from forming between the filter plates. In this case, drainage with sludge will leak from the failed sealing structure directly and escape from the filter cloth. Secondly, the pressure acting on the filter plate is equal to the product of multiplying the pressure intensity of the drainage by the area of the filter plate. That means the greater the diameter of the filter plate is, the larger the pressure of drainage acting on the filter plate is. Thus, in the pressing and filtering process, each filter plate impacted by rush of drainage at its two sides tends to sway acutely. In the event that the filter plate is not strong enough, it will break and soon reach the end of its service life. To make filter plates larger, the two issues have to be addressed first.

### SUMMARY

The primary objective of the present disclosure is to provide a filter plate that is designed to have a size larger than the conventional ones so as to provide improved efficiency and effectiveness when pressing and filtering drainage.

For achieving the foregoing objective, the present disclosure implements the technical schemes as described below.

The filter plate has two sides thereof peripherally provided with different ridges each formed as a closed loop, so that when two said filter plates are pressed together, the ridges at contacting sides of the adjacent filter plates are offset to jointly define a vacant space therebetween.

Therein, one of the sides of the filter plate has a flat top surface and the ridge at the other side the filter plate has a pointy or curved top surface.

When two said filter plates are pressed together, the vacant space formed between the flat top surface of the ridge of one of the filter plates and the pointy or curved top surface of the ridge of the other filter plate is closed.

The ridge having the flat top surface forms an inner-circle sealing and the ridge having the pointy or curved top surface forms an outer-circle sealing.

The vacant space has a width ranging between 3 mm and 5 mm.

At each of the sides of the filter plate, columnar protrusions are evenly distributed all over an area circled by the ridge, and all of the columnar protrusions have top surfaces thereof level with each other, wherein a base level of the filter plate from which the columnar protrusions are extended outward becomes thicker as it goes toward a periphery of the filter plate, and the columnar protrusion near the periphery of the filter plate has a height smaller a height of the columnar protrusion far away from the periphery of the filter plate.

Braces are radially arranged over each of the sides of the filter plate, so that when two said filter plates are pressed together, the corresponding braces on the adjacent filter plates press against each other.

The braces are grouped into an inner circle and an outer circle depending on radial positions thereof on the filter plate, wherein the inner circle contains four said braces, whose diameter ranges between 30 mm and 50 mm, and the outer circle contains six said braces, whose diameter ranges between 50 mm and 70 mm.

A diameter of the outer circle of the braces is 40-60% of a diameter of the filter plate, and a diameter of the inner circle of the braces is 20-30% of the diameter of the filter plate.

The filter plate is round and has a diameter of 0.6 m-1.2 m, while the base level of the filter plate has a thickness of 30-40 mm, so that a maximum thickness of the filter plate is 50-70 mm.

The filter plate is provided with ridges at its two sides so that when two filter plates are pressed together, the ridges at the contacting sides of the filter plates jointly form a vacant space with a predetermined volume. Therefore, if there is residue remaining at the sealing structure between the filter plates, when the filter plates are pressed together, the vacant space serves to receive the residue and prevent the sealing condition from degrading.

### BRIEF DESCRIPTION OF THE DRAWINGS

In the drawings, like reference characters generally refer to the same parts throughout the different views. The drawings are not necessarily to scale, emphasis instead generally being placed upon illustrating the principles of the disclosed embodiments. In the following description, various embodiments described with reference to the following drawings, in which:

FIG. 1 shows plural filter plates pressed together.

FIG. 2 is a partial, enlarged view of Area a of FIG. 1, particularly showing the vacant space 2 and therearound.

FIG. 3 is a partial, enlarged view of Area b of FIG. 1, particularly showing the base level 14 and columnar protrusions 13 of the filter plate.

FIG. 4 is a front view of the filter plate of the present disclosure.

### DETAILED DESCRIPTION

The disclosure as well as a preferred mode of use, further objectives and advantages thereof will be best understood by reference to the following detailed description of illustrative embodiments when read in conjunction with the accompanying drawings.

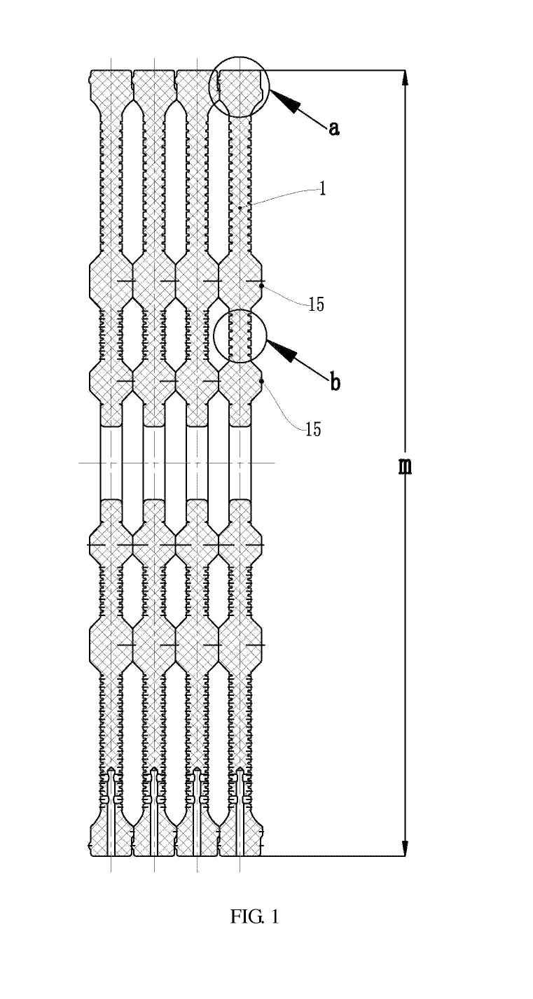

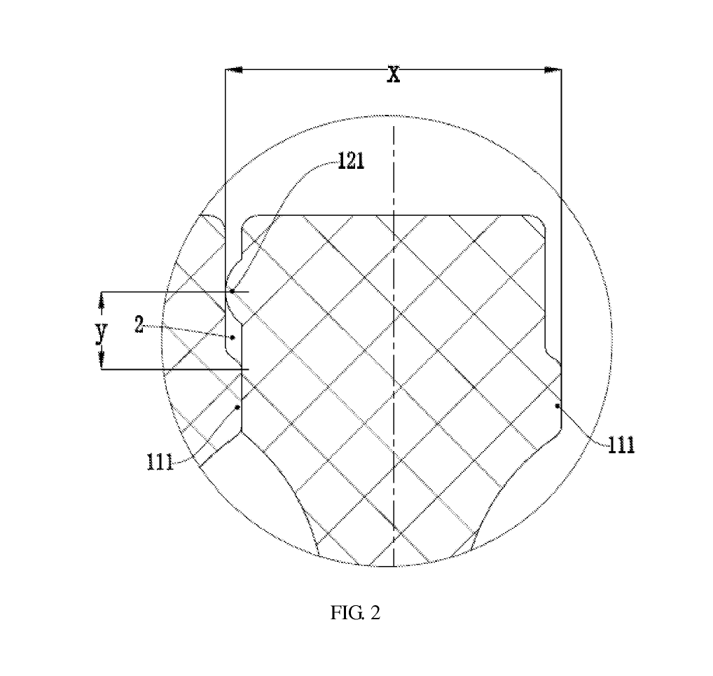

Referring to FIG. 1 through FIG. 3, according to the present embodiment, a filter plate has two ends (sides) of its plate body 1 peripherally provided with different ridges each formed as a closed loop. When two adjacent filter plates are pressed together, the ridges at the contacting surfaces of the plate bodies 1 are offset to jointly define a vacant space therebetween. The plate body 1 may be round or square. For a round plate body, the ridge is in the form of a circular raised edge. For a square plate body, the ridge is in the form of a square raised edge. The term “closed loop” related to the ridge refers to that the ridge is an endless loop running near the periphery of either side of the plate body 1 of the filter plate. In some prior-art devices, the adjacent filter plates are each peripherally provided with a rubber seal ring. In other prior-art devices, the filter plate has one side formed with a looped ridge and the other side formed with a matching circular groove. These existing designs seem capable of providing sealing effects, but are not so in practical use. When the solid leach residue formed as filter cakes is removed from the pressure filter, it is often that some residue remaining at the sealing structure between the adjacent filter plates, and this residue can cause the sealing structure to fail for the next session of pressing operation. The present disclosure creatively suggests two different loop-like ridges at two reverse sides of the plate body 1, wherein when two filter plates are pressed together, the ridge at the front of one filter plate and the ridge at the back of the other filter plate are offset and jointly define a vacant space 2 with a predetermined volume (as shown in FIG. 2). Therefore, in the event that some residue remaining at the sealing structure between the adjacent filter plates 3, when the filter plates once again pressed together, the vacant space 2 serves to accommodate a certain amount of residue, thereby preventing the residue from breaking the sealing condition between the filter plates.

Furthermore, the ridge at one side of the plate body 1 has a flat top surface 111, while the ridge at the other side of the plate body 1 has a pointy or curved top surface 121. The flat top surface 111 has surface contact with the other filter plate 3, so as to provide good sealing effects. The pointy or curved top surface 121 is designed to easily push the residue away where the ridge presses on the other plate body 1, thereby preventing the residue from standing in the way of the sealing structure and causing leakage.

When the filter plates are pressed together, the top surface 111 and the pointy or curved top surface 121 of the ridges of the adjacent filter plates form a closed vacant space 2. The disclosed design substantially provides double sealing that has improved sealing effects. The ridge at one side and the ridge at the other side of a filter plate, when working with those matching structures on another filter plate, form an inner-circle sealing and an outer-circle sealing, respectively, between which the vacant space 2 for receiving any potential residue is defined.

In the present embodiment, the inner ridge has the flat top surface 111, and the outer ridge has the pointy or curved top surface 121. The top surface 111 has surface contact with the adjacent plate body 1, so as to provide good sealing effects. For this reason, it is assigned to the inner-circle sealing for primarily withstand the pressure from the drainage. The pointy or curved top surface 121 is assigned to the outer-circle sealing for providing further sealing effects when secondarily withstand the pressure from the drainage.

The vacant space 2 has a width y of 3 mm-5 mm. A larger width may weaken the strength of the structure and degrade the sealing effects. A smaller width may be sooner packed by the residue and losing sealing capability. The width y of the vacant space 2 refers to a difference between the innermost radius and the outermost radius of the vacant space 2, as illustrated in FIG. 2.

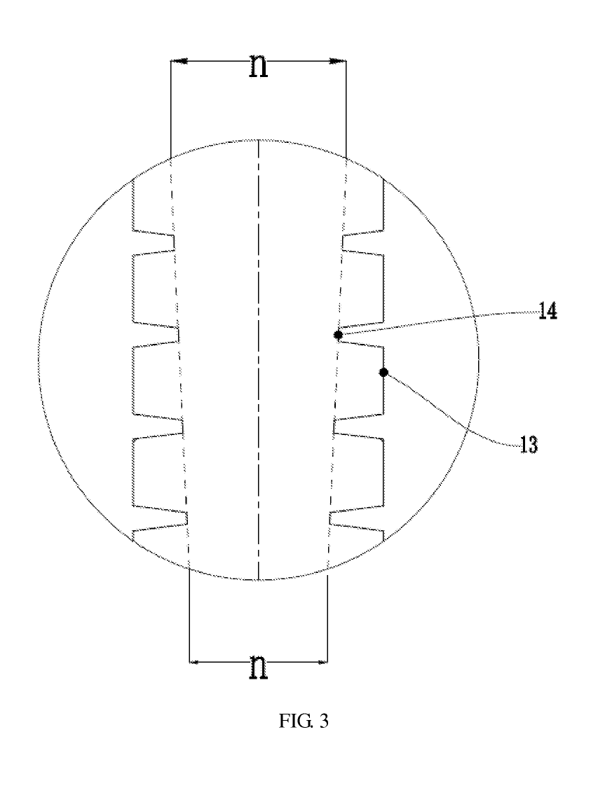

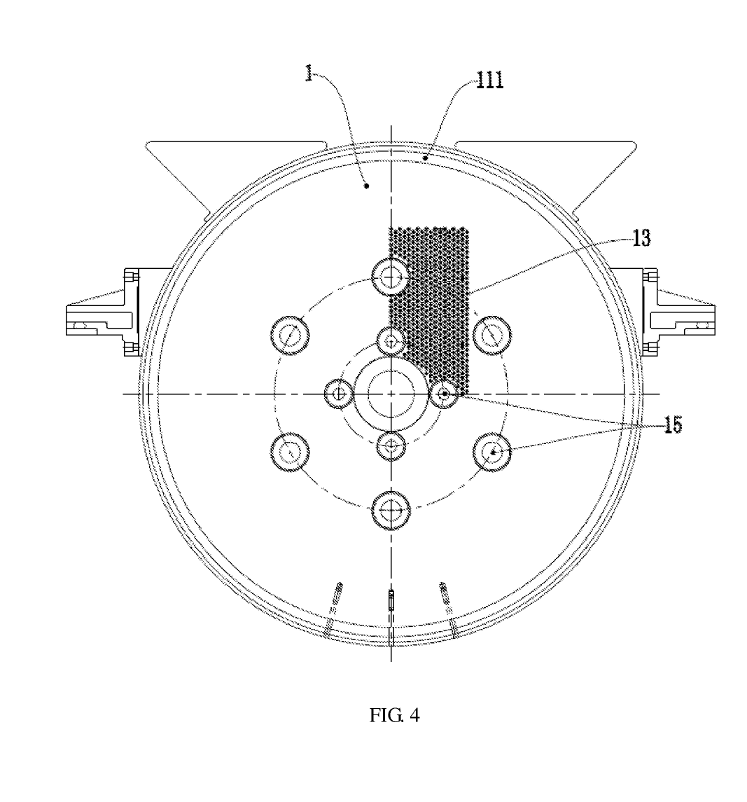

At each side of the plate body 1, columnar protrusions 13 are evenly distributed all over the area circled by the ridge although there are only some shown in FIG. 4 for the clarity of illustration. Referring to FIG. 3, all of the columnar protrusions 13 have their top surfaces level with each other. A base level 324 of the plate body 1 from which the columnar protrusions 13 are extended outward becomes thicker as it goes toward the periphery of the plate body 1, and the columnar protrusion 13 near the periphery of the plate body 1 has a height smaller that of the columnar protrusion 13 far away from the periphery of the plate body 1. The columnar protrusions 13 have their top surfaces level with each other, so as to press the solid leach residue between the filter plates 3 in to a cake that has an even thickness and is therefore easy to separate from the pressure filter.

Moreover, at each side of the plate body 1, braces 15 are radially arranged. When the two filter plates 3 are pressed together, the corresponding braces 15 on the adjacent plate bodies 32 press against each other. The braces 15 serve to prevent the large-sized filter plates 3 from swaying when receiving strong pressure from drainage.

The braces 15 are grouped into an inner circle and an outer circle depending on their radial positions on the plate body 1. The inner circle contains four braces 15, whose diameter ranges between 30 mm and 50 mm. The outer circle contains six braces 15, whose diameter ranges between 50 mm and 70 mm.

The diameter of the outer circle of the braces 15 is 40-60% of the diameter of the filter plate 3, and the diameter of the inner circle of the braces 15 is 20-30% of the diameter of the filter plate 3. The braces 15 serve to prevent the filter plate from swaying under extreme pressure from the drainage. Since such sway tends to happen at the central part of the filter plate 3, the inner and outer circles of braces 15 can more effectively ensure stability of the filter plate during the filtering process.

In the present embodiment, the filter plate is round and has a diameter m of 0.6 m-1.2 m. The thickness n of the base level of the filter plate is 30 mm-40 mm. The maximum thickness x of the filter plate is 50 mm-70 mm. The maximum thickness x of the plate body 1 refers to the maximum distance between top surfaces of the ridges at two sides of the plate body 1.

The present disclosure has been described with reference to the preferred embodiments and it is understood that the embodiments are not intended to limit the scope of the present disclosure. Moreover, as the contents disclosed herein should be readily understood and can be implemented by a person skilled in the art, all equivalent changes or modifications which do not depart from the concept of the present disclosure should be encompassed by the appended claims.

What is claimed is:

1. A filter plate having:
two sides thereof are peripherally provided with different ridges each formed as a closed loop, so that when two said filter plates are pressed together, the ridges at contacting sides of the adjacent filter plates are offset to jointly define a vacant space therebetween.

2. The filter plate of claim 1,
wherein one of the sides of the filter plate has a flat top surface and the ridge at the other side the filter plate has a pointy or curved top surface.

3. The filter plate of claim 2,
wherein when two said filter plates are pressed together, the vacant space formed between the flat top surface of the ridge of one of the filter plates and the pointy or curved top surface of the ridge of the other filter plate is closed.

4. The filter plate of claim 3,
wherein the ridge having the flat top surface forms an inner-circle sealing and the ridge having the pointy or curved top surface forms an outer-circle sealing.

5. The filter plate of claim 1,
wherein the vacant space has a width ranging between 3 mm and 5 mm.

6. The filter plate of claim 1,
wherein at each of the sides of the filter plate, columnar protrusions are evenly distributed all over an area circled by the ridge, and all of the columnar protrusions have top surfaces thereof level with each other, wherein a base level of the filter plate from which the columnar protrusions are extended outward becomes thicker as it goes toward a periphery of the filter plate, and the columnar protrusion near the periphery of the filter plate has a height smaller a height of the columnar protrusion far away from the periphery of the filter plate.

7. The filter plate of claim 5,
wherein braces are radially arranged over each of the sides of the filter plate, so that when two said filter plates are pressed together, the corresponding braces on the adjacent filter plates press against each other.

8. The filter plate of claim 7,
wherein the braces are grouped into an inner circle and an outer circle depending on radial positions thereof on the filter plate, wherein the inner circle contains four said braces, whose diameter ranges between 30 mm and 50 mm, and the outer circle contains six said braces, whose diameter ranges between 50 mm and 70 mm.

9. The filter plate of claim 9,
wherein a diameter of the outer circle of the braces is 40-60% of a diameter of the filter plate, and a diameter of the inner circle of the braces is 20-30% of the diameter of the filter plate.

10. The filter plate of claim 8,
wherein the filter plate is round and has a diameter of 0.6 m-1.2 m, while the base level of the filter plate has a thickness of 30-40 mm, so that a maximum thickness of the filter plate is 50-70 mm.
